(19) United States
(12) Patent Application Publication
(10) Pub. No.: US 2006/0190267 A1
(43) Pub. Date: Aug. 24, 2006

(54) Voice activated clock

(75) Inventor: Raymond Chan, Hong Kong (HK)

Correspondence Address: LEYDIG VOIT & MAYER, LTD, 700 THIRTEENTH ST. NW, SUITE 300, WASHINGTON, DC, 20005-3960, US

(73) Assignee: IDT Technologies Limited, Hunghom (HK)

(21) Appl. No.: 11/061,617

(22) Filed: Feb. 22, 2005

(51) Int. Cl. G10L 21/00

(52) U.S. Cl. 704/275

(57) ABSTRACT

A voice activated clock has a body, a clock projector for displaying time, and an electronic operating circuit that includes a clock circuit for performing various clock functions including operating the projector to display time. The operating circuit further includes a voice input circuit for inputting a voice command issued by a user, a memory, and a voice processing circuit for associating an input voice command with a corresponding one of the clock function, storing the command in the memory, and comparing voice command later input by the voice input circuit with the command stored in the memory for matching, and operating the clock circuit to perform the associated clock function in the event of a match.

### BACKGROUND OF THE INVENTION

More particularly, but not exclusively, the invention relates to a voice activated radio-controlled projection clock.

Voice clocks are known, which are clocks that are capable of indicating time by voice. Voice activated clocks, i.e. clocks that are controlled by voice, are rare or not satisfactory in terms of performance or convenience of use.

The invention seeks to provide a new or improved voice activated clock.

### SUMMARY OF THE INVENTION

According to the invention, there is provided a voice activated clock comprising a body, a display device associated with the body for displaying time, and an electronic operating circuit in the body, which includes a clock circuit for performing a plurality of clock functions including operating the display device to display time. The operating circuit further includes a voice input circuit for inputting a voice command issued by a user, a memory, and a voice processing circuit for associating said input command with a corresponding one of the clock functions and then storing the command in the memory, and subsequently comparing a later command input by the voice input circuit with the command stored in the memory for matching to operate the clock circuit to perform the associated clock function.

Preferably, the voice processing circuit is adapted to store in the memory an initial command input by the voice input circuit as a password identifying said user and to correlate all subsequent input commands associated with corresponding clock functions and stored in the memory with the password such that those clock functions can only be activated by the same user.

More preferably, the voice processing circuit is adapted to subsequently compare a later command input by the voice input circuit with the password stored in the memory for matching to identify said user before enabling the voice input circuit to input a further command for performing a clock function.

Further more preferably, the voice processing circuit is adapted to enable the voice input circuit to input a said further command within a predetermined timeout period, and at expiry of the timeout period the voice processing circuit is adapted to compare a later command input by the voice input circuit with the password stored in the memory for matching to identify said user.

Yet further more preferably, the voice processing circuit is adapted to enable the voice input circuit to input more than one said further command sequentially within respective predetermined timeout periods.

It is preferred that the voice processing circuit is adapted to store in the memory more than one initial command issued by different users as respective passwords identifying said users and, for each of said users, to correlate all subsequent input commands associated with corresponding clock functions and stored in the memory with the respective password such that those clock functions can only be activated by the respective user.

In a specific construction, the operating circuit includes a microphone connected to the voice input circuit for inputting voice commands.

In a preferred embodiment, the operating circuit includes an audio generator controlled to announce appropriate voice messages indicating the types of voice commands as between for password and for clock functions to be input by the voice input circuit.

More preferably, the audio generator is also controlled to announce time and time related information.

In a preferred embodiment, the display device comprises a clock projector for projecting an image to display time.

More preferably, one of the clock functions is displaying time by the projector, with which function a command is associated by the voice processing circuit, such that input of the command will operate the projector to display time.

### BRIEF DESCRIPTION OF DRAWINGS

The invention will now be more particularly described, by way of example only, with reference to the accompanying drawings, in which:

FIG. 1 is a front elevational view of an embodiment of a voice activated clock in accordance with the invention;

FIG. 2 is a top plan view of the clock of FIG. 1;

FIG. 3 is a schematic functional block diagram of an electronic operating circuit of the clock of FIG. 1; and

FIG. 4 is a schematic flow diagram illustrating the operation of the clock of FIG. 1.

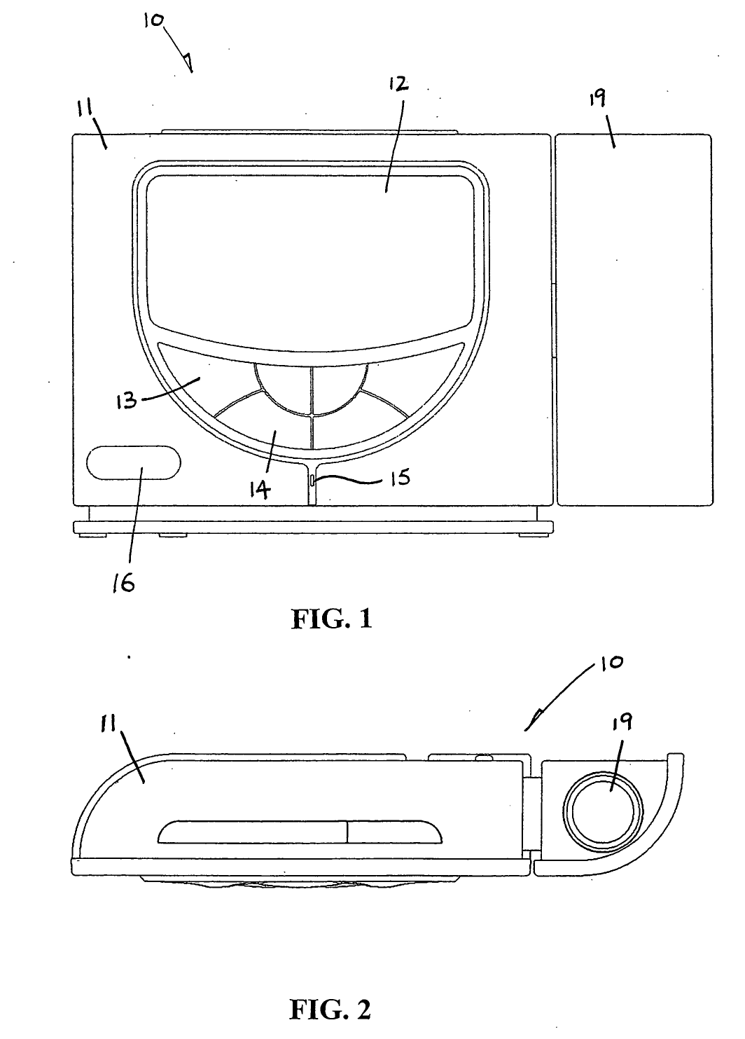

### DETAILED DESCRIPTION OF PREFERRED EMBODIMENT

Referring to the drawings, there is shown a voice activated clock 10 embodying the invention, which has a flat rectangular body 11 standing upright on one side thereof and an oblong clock projector 19 hinged to the right side of the body 11. On the front surface of the clock body 11, there are an LCD display 12, a set of operating buttons including a TALK button 13 and a SOUND/VOICE on/off button 14, and a microphone 15 and a speaker 16 below the set of buttons. The projector 19 utilises an LED with associated lens/reflector to project a light beam through an LCD time panel, as is generally known in the art. It is pivotable about a horizontal central axis of the clock body 11 to project a digital clock image at an adjustable angle upwards for example on the ceiling surface.

Housed in the clock body 11 is an electronic operating circuit 20 which comprises a main control unit or MCU 21 and, connected thereto, a solid-state voice input circuit 22, a solid-state voice controller (processor) 23 and a RAM memory module 24. The memory module 24 is separately connected to the voice input circuit 22 and voice controller 23. The MCU 21 incorporates a built-in clock circuit for performing various clock functions including operating the projector 19 to display time. The MCU 21 and the voice controller 23 co-operate to exercise control over the rest of the operating circuit 20 including the voice input circuit 22.

The voice input circuit 22 works with the microphone 15 to learn and record, in a predetermined order, a password and a set of predetermined commands announced by a user and to store these speech segments in the memory module 24, during an initial learning/training mode of the subject clock 10 in preparation for normal operation of the clock 10. During normal clock operation, the voice input circuit 22 with the microphone 15 serves to receive/input said password and commands issued by the user.

The voice controller 23 is programmed to process and recognise such input speech segments, which will be analysed and compared with the pre-recorded password and commands, as appropriate, based on their properties or characteristics for speech recognition, including for example frequency, pitch, harmonics, intonation and amplitude, such that the segments can be distinguished not only by their content (i.e. from one segment to another) but also the voice of the issuing party i.e. personal identity.

In this regard, the voice controller 23 is designed to handle the voices of two users 1 and 2 such that the clock 10 can be operated by either the husband or wife, for example. The ability to differentiate between recorded users, and to exclude any third party users, is especially preferred for the use of alarm functions. The clock 10 provides two alarms 1 and 2 which can be set independently and can be used by the two users separately for different alarm times. In the case of use of remote alarm vibrators, which are typically motor-driven and are designed to respond to an electrical alarm signal received by wire or via an RF link from the clock 10, both alarms 1 and 2 can be set and used concurrently by the users without disturbing the other when set off.

During normal clock operation, the voice controller 23 works with the speaker 16 to announce or playback factory-recorded or synthesized messages for guiding the user to operate the clock 10 and in particular to input password and then commands for indicating time, alarm status and temperature, etc. as hereinafter described.

Also connected to the MCU 21 are the clock projector 19 controlled thereby, a radio-frequency (RF) clock receiver as represented by an antenna 25 for receiving an RF time/calendar signal broadcast by the relevant local authority for synchronization, and a thermal sensor 26 for measuring the ambient temperature. These information and data are to be stored in the memory module 24 and displayed on the LCD display 12. It therefore follows that the subject clock 10 is capable of displaying time (either local or overseas time and including various alarm functions) as well as temperature and also any other atmospheric/weather condition data such as pressure and humidity if the relevant sensors are also installed.

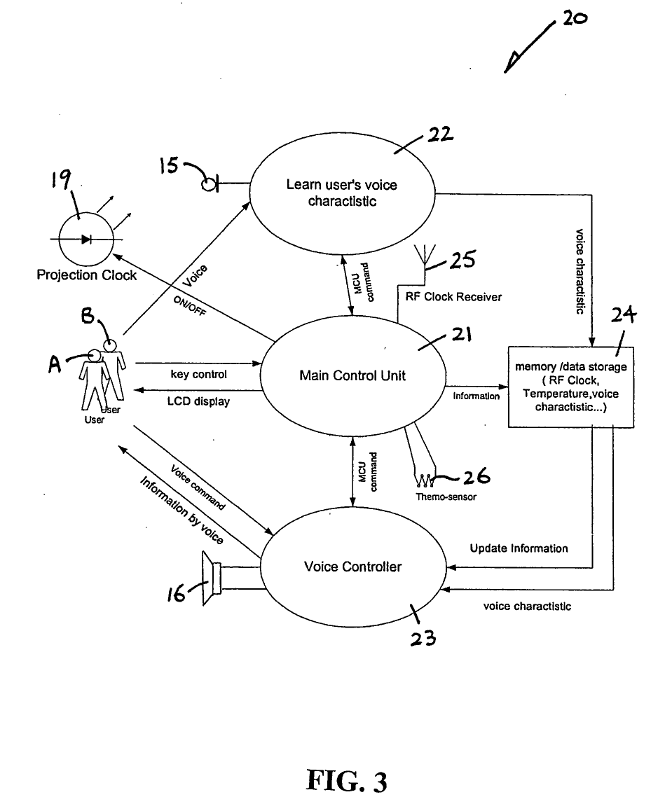

As shown in FIG. 3, either user 1 or 2 may operate the clock 10 by key control using the buttons 13 and 14 for example and/or by voice via the microphone 15 and voice input circuit 22, and the voice controller 23 responds to the verbal password/commands by providing appropriate outputs on the LCD display 12 or via the speaker 16.

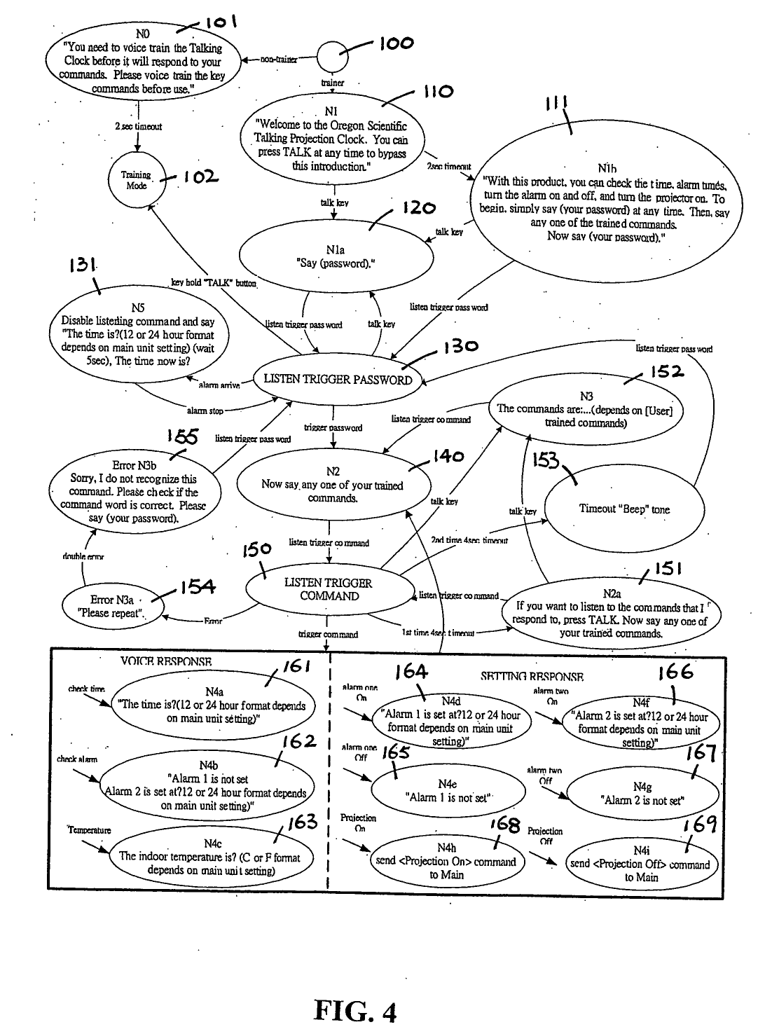

FIG. 4 illustrates the flow of operation of the subject clock 10, which is under the control of the MCU 21 and the voice controller 23. The operation starts (block 100) at a state of first use for example or after a system reset. For a new user, the clock 10 will enter a training mode (block 102) at 2-second timeout after announcing the message “You need to voice train the Talking Clock before it will respond to your commands. Please voice train the key commands before use” (block 101).

In the training mode, the user is invited to announce an initial command of his/her choice at the microphone 15 for input, which is stored in the memory 24 and will be used by the voice controller 23 as a password identifying the user. Afterwards, the user is required to say a set of commands one after another and each twice for confirmation, and as they are announced the voice controller 23 associates each of them with a corresponding specific clock function and then stores them in the memory 24 as trained commands. The voice controller 23 also correlates all these function commands with the password initially set such that the relevant clock functions can only be activated by the same user. Up to two users (as mentioned above) can be trained on after the other, each being identified by a password and associated with a set of trained commands.

For a trained user, the clock 10 will say “Welcome to the Oregon Scientific Talking Projection Clock. You can press TALK at any time to bypass this introduction” (block 110). At 2-second timeout, the introduction will follow as “With this product, you can check the time, alarm times, turn the alarm on and off, and turn the projector on. To begin, simply say (your password) at any time. Then, say any one of the trained commands. Now say (your password)” (block 111). If the TALK button 13 is pressed before or during the introduction, the clock 10 will mention “Say (password)” (block 120). In either case, the clock 10 then listens and waits for the password (block 130) to trigger clock operation. This condition represents the normal state of the clock 10. If desired, the user may press and hold the TALK button 13 to go (back) to the training mode (block 102) if necessary, for re-training or new user training.

Password is useful in authenticating a user, to avoid unauthorised use in general or to select the right set of trained commands for use by that user as opposed to the other set owned by the second authorised user. Upon input of a password, the voice controller 23 will compare it with the password(s) stored in the memory 24 for matching in terms of voice characteristics to identify the user. After the user has been identified, the voice controller 23 will immediately instruct the MCU 21 to enable the voice input circuit 22 to input a function command.

At a preset alarm time, the clock 10 will disable the listening command and say “The time is? (12 or 24 hour format depends on main unit setting) (wait 5 sec) The time now is?” (block 131), and afterwards listening (block 130) will resume. Upon accepting the password, the clock 10 will state “Now say any one of your trained commands” (block 140), which is then followed by listening for a command (block 150) to trigger a specific clock function.

There are the following three possible outcomes in the absence of a valid function command from the user:

(A) If nothing is heard at 4-second timeout, the clock 10 will say “If you want to listen to the commands that I respond to, press TALK. Now say any one of your trained commands” (block 151) and then, upon pressing of the TALK button 13, “The commands are: . . . (depends on [user] trained commands)” (block 152), and subsequently the clock 10 will repeat the request for one of those trained commands (block 140). All the trained commands will also be read out upon pressing of the TALK button 13 right at command listening (block 150).

(B) If nothing is heard at another 4-second timeout, the clock 10 will emit a timeout beep tone (block 153) and then return two steps back to password listening (block 130), asking for re-entry of the password.

(C) Upon receiving a wrong or unclear command, the clock 10 will ask for it again by saying “Please repeat” (block 154). In the case of a double error, the clock 10 will say “Sorry, I do not recognize this command. Please check if the command word is correct. Please say (your password)” (block 155) and then return two steps back to password listening (block 130), requiring re-entry of the password.

The voice controller 23 is also responsible for validating function commands by comparing an input command with the trained commands stored in the memory 24 for matching in terms of voice characteristics. Upon finding a trained command that matches with the input command, the voice controller 23 will immediately ask the MCU 21 to perform the associated function.

The subject clock 10 will perform an appropriate one of the following specific functions (blocks 161 to 169) in response to a valid voice command:

| Commands | Data Responses |
|---|---|
| <Check Time> | “The time is ?” |
| <Check Alarm> | “Alarm 1 is not set, Alarm 2 is set at ?” |
| <Temperature> | “The indoor temperature is ?” |

| Commands | Setting Responses |
|---|---|
| <Alarm 1 On> | “Alarm 1 is set at ?” |
| <Alarm 1 Off> | “Alarm 1 is not set” |
| <Alarm 2 On> | “Alarm 2 is set at ?” |
| <Alarm 2 Off> | “Alarm 2 is not set” |
| <Projection On> | send <Projection On> command to MCU |
| <Projection Off> | send <Projection Off> command to MCU |

The clock projector 19 will be operated to display time or turned off by the MCU 21 upon receipt of an associated <Projection On> or <Projection Off> command input by the user.

Upon completion of the requested function, the MCU 21 will return the clock 10 to the preceding state of inviting input of a trained commands (block 140). Say no further command is announced at expiry of the relevant timeout period, the normal state of password input (block 130) will be restored. Under the control of MCU 21, the voice controller 23 enables the voice input circuit 22 to input more than one function command such that a series of functions can be performed, such as time check and then alarm setting before the user goes to bed.

The SOUND/VOICE button 14 may be pressed to switch on and off the various sound/voice functions, including both voice activation and voice output. In the latter case, the clock 10 would perform like an ordinary projection clock.

The invention has been given by way of example only, and various modifications of and/or alterations to the described embodiment may be made by persons skilled in the art without departing from the scope of the invention as specified in the appended claims.

1. A voice activated clock comprising:
a body;
a display device associated with the body for displaying time; and
an electronic operating circuit in the body, the electronic operating circuit including:
a clock circuit for performing a plurality of clock functions including operating the display device to display time;
a voice input circuit for inputting a voice command issued by a user;
a memory; and
a voice processing circuit for associating an input voice command with a corresponding one of the clock functions, storing the voice command in the memory, and. subsequently comparing a voice command input later by the voice input circuit with the voice command stored in the memory for matching to operate the clock circuit to perform an associated clock function.

2. The voice activated clock as claimed in claim 1, wherein the voice processing circuit stores in the memory an initial voice command input by the voice input circuit as a password identifying a user and correlates all subsequently input voice commands associated with corresponding clock functions and stored in the memory with the password such that those clock functions can only be activated by the same user.

3. The voice activated clock as claimed in claim 2, wherein the voice processing circuit subsequently compares a voice command later input by the voice input circuit with the password stored in the memory for matching to identify the user before enabling the voice input circuit to input a further voice command for performing a clock function.

4. The voice activated clock as claimed in claim 3, wherein the voice processing circuit enables the voice input circuit to input a further voice command within a predetermined timeout period, and at expiry of the timeout period the voice processing circuit compares a voice command later input by the voice input circuit with the password stored in the memory for matching to identify the user.

5. The voice activated clock as claimed in claim 4, wherein the voice processing circuit enables the voice input circuit to input more than one further voice command sequentially within respective predetermined timeout periods.

6. The voice activated clock as claimed in any claim 2, wherein the voice processing circuit stores in the memory more than one initial voice command issued by different users as respective passwords identifying the users and, for each of the users, correlates all subsequently input voice commands associated with corresponding clock functions and stored in the memory with the respective passwords such that those clock functions can only be activated by the respective user.

7. The voice activated clock as claimed in claim 1, wherein the operating circuit includes a microphone connected to the voice input circuit for inputting voice commands.

8. The voice activated clock as claimed in claim 1, wherein the operating circuit includes an audio generator controlled to announce appropriate voice messages indicating voice commands for a password and for clock functions to be input by the voice input circuit.

9. The voice activated clock as claimed in claim 8, wherein the audio generator is controlled to announce time and time-related information.

10. The voice activated clock as claimed in claim 1, wherein the display device comprises a clock projector for projecting an image displaying time.

11. The voice activated clock as claimed in claim 10, wherein one of the clock functions is displaying time by the projector, with which function a command is associated by the voice processing circuit, such that input of the command associated with displaying time operates the projector to display time.
